(19) United States
(12) Patent Application Publication
(10) Pub. No.: US 2012/0078760 A1
(43) Pub. Date: Mar. 29, 2012

(54) Accounting System for Automated Transaction Apparatuses

(76) Inventor: Po-Chang Yen, Tainan City (TW)

(21) Appl. No.: 12/893,002

(22) Filed: Sep. 29, 2010

(51) Int. Cl. G06Q 10/00

(52) U.S. Cl. 705/30

(57) ABSTRACT

An accounting system for a plurality of automated transaction apparatuses includes a first control unit electrically connected to a computer. A first transmission unit is electrically connected to the first control unit. A second control unit is electrically connected to each automated transaction apparatus. A second transmission unit is electrically connected to each second control unit. Control commands generated by the first control unit are sent to the second transmission units via the first transmission unit. Each second control unit receives one of the control commands and reads the transaction data of one of the automated transaction apparatuses. Each second transmission unit transmits the transaction data of one of the automated transaction apparatuses to the first transmission unit. The first control unit reads the transaction data transmitted to the first transmission unit and sends the transaction data to the computer to proceed with accounting process and to output accounts data.

### BACKGROUND OF THE INVENTION

The present invention relates to an accounting system for automated transaction apparatuses and, more particularly, to an accounting system that can automatically proceed with transaction with customers using automated transaction apparatuses such as vending machines and that can acquire accounting data of the automated transaction apparatuses to proceed with accounting process.

A wide variety of automated apparatuses has been invented and utilized in differing fields. A type of automated transaction apparatus such as a vending machine or a game machine includes a plurality of buttons and information of prices of commodities to be sold. The type of automated transaction apparatus also includes a coin or bill receiving device through which a customer can insert coins or bills into the automated transaction apparatus to obtain the desired commodities or services by pressing the buttons. The automated transaction apparatuses are placed in different places and, thus, require regular (weekly or monthly) checking by the owner for retrieving the money in the automated transaction apparatuses and for supplying the commodities. Then, the owner of the automated vending apparatuses proceeds with accounting process based on the money and the number of the sold commodities to obtain the turnover.

There are often a lot of coins in the money received and, thus, require considerable labor and time to count the money for the accounting process. Taking vending machines as an example, the owner can not immediately know the number of the commodities sold and, thus, can not supply the commodities that have been sold out in each vending machine if the regular checking is not due, leading to lowered turnover. On the other hand, the regular checking is a waste of time and money for automated vending apparatuses having poor business. Furthermore, the accounting system used for the traditional automated vending apparatuses can not allow the owner to know every transaction and is not convenient to the accounting process, leading to increased costs to the owner.

Thus, a need exists for an accounting system that can remotely access the automated transaction apparatuses to acquire every transaction data of the automated vending apparatuses.

### BRIEF SUMMARY OF THE INVENTION

The present invention solves this need and other problems in the field of easy accounting process for automated transaction apparatuses by providing, in a preferred form, an accounting system for a plurality of automated transaction apparatuses including a first control unit electrically connected to a computer. The first control unit is capable of generating a plurality of control commands through operation of the computer. A first transmission unit is electrically connected to the first control unit and capable of receiving transaction data of each of the plurality of automated transaction apparatuses and sending the control commands generated by the first control unit. A second control unit is electrically connected to each of the plurality of automated transaction apparatuses. Each second control unit stores an identification code and transaction data of one of the plurality of automated transaction apparatuses electrically connected to the second control unit. A second transmission unit is electrically connected to each second control unit and capable of sending the transaction data of one of the plurality of automated transaction apparatuses read by one of the second control units to the first transmission unit electrically connected to the automated transaction apparatus.

When the first control unit generates the plurality of control commands, the plurality of control commands is sent to the second transmission units via the first transmission unit. Each second control unit receives one of the plurality of control commands from one of the second transmission units and reads the transaction data of one of the plurality of automated transaction apparatuses electrically connected to the second control unit. Each second transmission unit transmits the transaction data of one of the plurality of automated transaction apparatuses electrically connected to the second transmission unit to the first transmission unit. The first control unit reads the transaction data transmitted to the first transmission unit and sends the transaction data to the computer to proceed with accounting process and to output accounts data.

In the most preferred form, the transmission unit sends the plurality of control commands through a global system for mobile communication, and the second transmission units send the transaction data through the global system for mobile communication.

A cell phone can be utilized to control the first control unit through the global system for mobile communication to generate the plurality of control commands. The first transmission unit can send a message containing the accounts data to the cell phone through the global system for mobile communication.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a schematic block diagram of an accounting system according to the preferred teachings of the present invention.

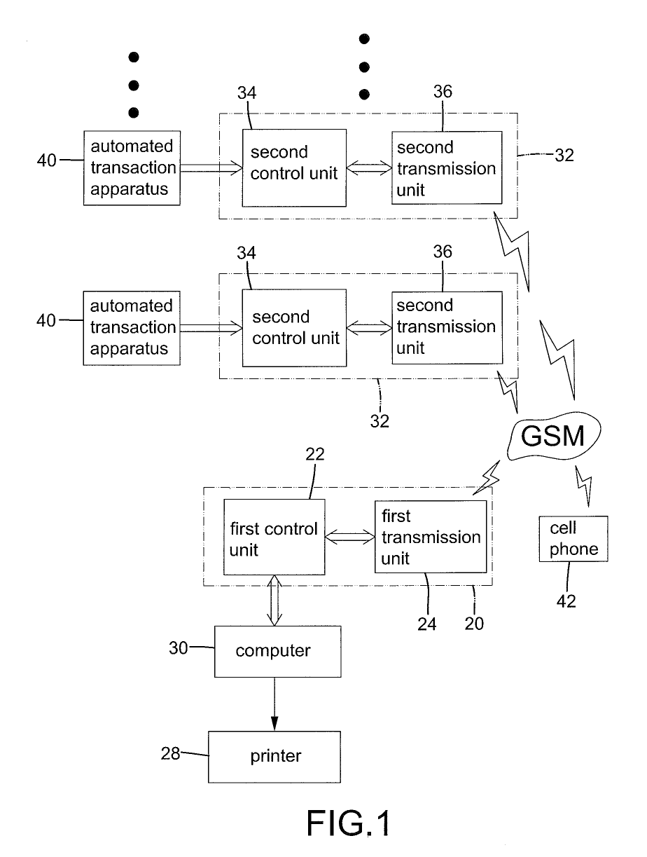

FIG. 2 shows a schematic view of disposition of hardware using the accounting system according to the preferred teachings of the present invention.

FIG. 3 shows a flow chart illustrating an example of use of the accounting system according to the preferred teachings of the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

An accounting system according to the preferred teachings of the present invention is shown in the drawings and generally includes a host 20 and a computer 30 (such as a personal computer). The host 20 and the computer 30 are located in a remote control center 46. The host 46 includes a first control unit 22 having a processing IC (integrated circuit) and a memory. The first control unit 22 further includes a plurality of connectors. The memory of the first control unit 22 stores software required by the first control unit 22. The processing IC processes the data received by the first control unit 22. The connectors can be USB (Universal Serial Bus) or serial ports compatible with RS-232 or RS-485. The host 20 further includes a first transmission unit 24. The first transmission unit 24 can be a cell phone or a messaging device capable of sending messages. The first transmission unit 24 is electrically connected to the first control unit 22 and can transmit control commands or receive transaction data. The host 2 is electrically connected by the USB to the computer 30. The first transmission unit 24 is connected to the Global System for Mobile Communications (GSM). In the most preferred form shown, the accounting system further includes a printer 28 electrically connected by a serial port to the computer 30.

The accounting system according to the preferred teachings of the present invention is utilized with a plurality of automated transaction apparatuses 40 such as vending machines. The accounting system according to the preferred teachings of the present invention further includes a sub machine 32 in each automated transaction apparatus 40. Each sub machine 32 includes a second control unit 34 and a second transmission unit 36. The second transmission unit 36 can be a cell phone or a messaging device capable of sending messages. The second control unit 34 includes a processing IC (integrated circuit) and a memory. The second control unit 34 further includes a plurality of connectors. The memory of the second control unit 34 of each automated transaction apparatus 40 stores software required by the second control unit 34 and a unique identification code of the automated transaction apparatus 40. The owner of the automated transaction apparatuses 40 can record the transaction data regarding the traded commodities, locations of the automated transaction apparatuses 40, etc received by the second control unit 34. The connectors can be USB or serial ports compatible with RS-232 or RS-485. The second transmission unit 36 is electrically connected to the second control unit 34 and can receive control commands or send the transaction data of the automated transaction apparatuses 40. The second transmission unit 36 is connected to the Global System for Mobile Communications (GSM).

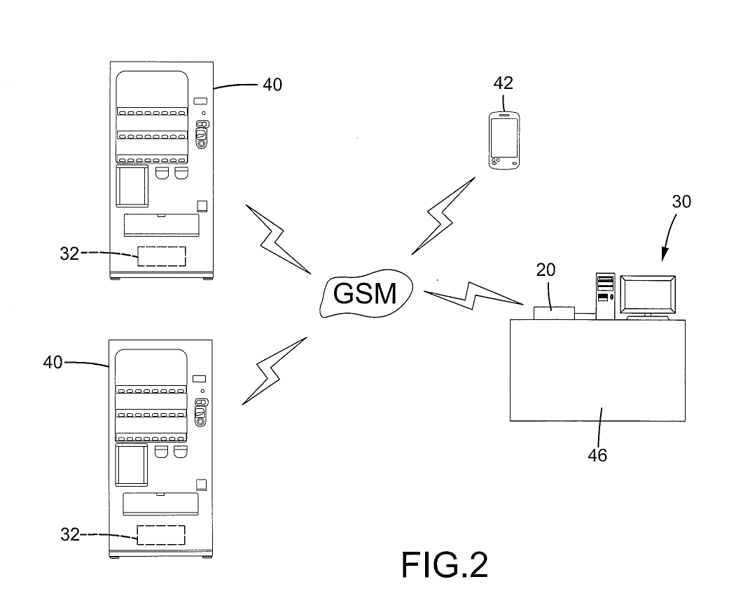

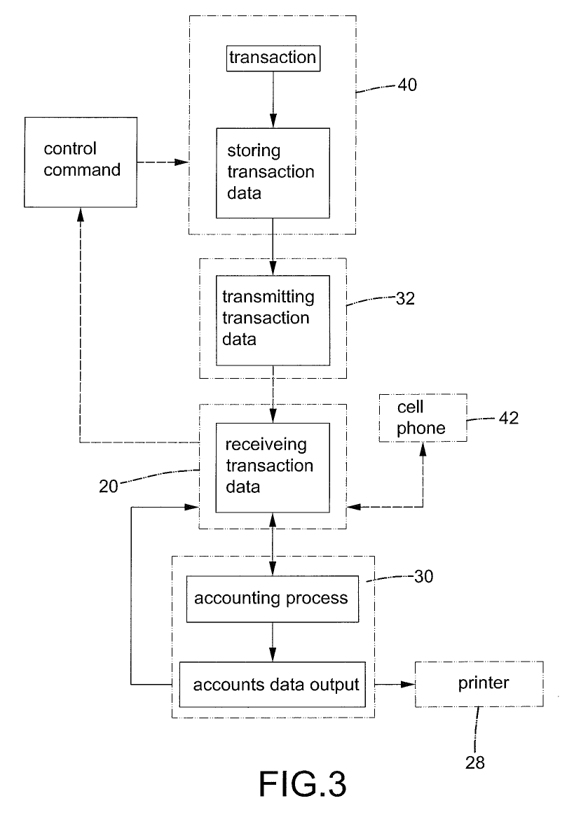

With reference to FIGS. 2 and 3, in use, each sub machine 32 is mounted in one of the automated transaction apparatuses 40, and the host 20 is mounted in the remote control center 46. Through operation of the computer 30, the first control unit 22 of the host 20 can control the first transmission unit 24 to send out control commands. Furthermore, the host 20 can receive the transaction data from each sub machine 32 transmitted through the GSM.

Operation of the accounting system according to the preferred teachings of the present invention will now be described with reference to FIG. 3.

A. Transaction: The operative interfaces built in each automated transaction apparatus 40 allow a customer to proceed with transaction. The customer can insert one or more coins or bills into the automated transaction apparatus 40 (such as a vending machine) to obtain permission to operate the vending machine. A selected commodity is released into an open compartment in the vending machine when an associated button is pressed. The customer gets the commodity (and the change if the money paid is more than the price of the commodity). A transaction is accomplished.

B. Storage of transaction data: Each automated vending apparatus 40 stores the transaction data regarding at least one transaction in the memory built in the second control unit 34 in the sub machine 32 thereof. The transaction data includes the items of the commodities, the amount of money involved in each transaction, the number of transactions, etc.

C. Transmission of control commands: Through operation of the computer 30 in the remote control center 46, the owner controls the first control unit 22 of the host 20 to generate control commands corresponding to the identification codes of the automated transaction apparatuses 40. The control commands are sent through GSM to the sub machines 32 in the automated transaction apparatuses 40 and received by the second transmission unit 36 in each sub machine 32. The second control unit 34 of each automated transaction apparatus 40 reads the control command and compares it with the defaulted identification code of the automated transaction apparatus 40. The second control unit 34 reads the transaction information if the identification code matches the defaulted identification code.

D. Transmission of transaction data: The transaction data read by the second control unit 34 of the sub machine 32 and the associated identification code of the automated transaction apparatus 40 are sent by the second transmission unit 36 to the host 20 in the remote control center 46 through GSM.

E. Receiving transaction data: The first transmission unit 24 of the host 20 receives the transaction data and sends the transaction data to the memory (such as hard disks or the like) of the computer 30 through the first control unit 22.

F. Accounting process: The computer 30 in the remote control center 46 calculates each transaction and proceeds with accounting process. The number of remaining commodities in each automated transaction apparatus 40 can be known based on the transaction data and the identification codes. Workers can be sent out to check the automated transaction apparatuses 40 and to supply the commodities when the number of the commodities is lower than the defaulted number.

G. Output of accounts data: The accounts data after calculation can be printed out by the printer 28 of the computer 30.

Besides the host 20, the user of the accounting system according to the preferred teachings of the present invention can generate the control commands by using a cell phone 42 to operate the host 20 through GSM. Operation of the cell phone 42 to control the host 20 for generating the control commands can be achieved in a manner substantially the same as direct controlling by the computer 30 except for transmission of the control commands and the output of the accounts data. Specifically, in the step of transmission of control commands, the owner uses the cell phone 42 to send a signal containing the identification codes of the automated transaction apparatuses 40 to the first transmission unit 24 of the host 20 through the GSM. The first control unit 22 generates control commands related to the identification codes of the automated transaction apparatuses 40. The control commands are sent from the first transmission unit 24 to the sub machines 32 via the GSM and received by the second transmission unit 36 in each sub machine 32. The control unit 36 of each sub machine 32 reads the control command and compares it with the defaulted identification code of the automated transaction apparatus 40. The second control unit 34 reads the transaction information if the identification code matches the defaulted identification code. In the step of output of accounts data, the accounts data business after calculation is sent by the computer 30 to the first control unit 22 of the host 20. The first transmission unit 24 of the first control unit 22 of the host 20 sends a message containing the accounts data to the cell phone 42 via the GMS. The accounts data can be shown on the screen of the cell phone 42.

The accounting system according to the preferred teachings of the present invention allows the owner to remotely acquire the transaction data of each automated transaction apparatus 40 to learn the number of the unsold commodities of the automated transaction apparatuses 40. Furthermore, the accounting system according to the preferred teachings of the present invention allows the owner to obtain the transaction data of each automated transaction apparatus 40 at any time, increasing the accounting efficiency.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An accounting system for a plurality of automated transaction apparatuses comprising:
a first control unit electrically connected to a computer, with the first control unit capable of generating a plurality of control commands through operation of the computer;
a first transmission unit electrically connected to the first control unit, with the first transmission unit capable of receiving transaction data of each of the plurality of automated transaction apparatuses and sending the control commands generated by the first control unit;
a plurality of second control units each electrically connected to one of the plurality of automated transaction apparatuses, with each of the plurality of second control units storing an identification code and transaction data of one of the plurality of automated transaction apparatuses electrically connected to the second control unit; and
a plurality of second transmission units each electrically connected to one of the plurality of second control units, with the second transmission unit capable of sending the transaction data of one of the plurality of automated transaction apparatuses read by one of the plurality of second control units to the first transmission unit electrically connected to the automated transaction apparatus,
wherein when the first control unit generates the plurality of control commands, the plurality of control commands is sent to the plurality of second transmission units via the first transmission unit, each of the plurality of second control units receives one of the plurality of control commands from one of the plurality of second transmission units and reads the transaction data of one of the plurality of automated transaction apparatuses electrically connected to the second control unit, each of the plurality of second transmission units transmits the transaction data of one of the plurality of automated transaction apparatuses electrically connected to the second transmission unit to the first transmission unit, the first control unit reads the transaction data transmitted to the first transmission unit and sends the transaction data to the computer to proceed with accounting process and to output accounts data.

2. The accounting system as claimed in claim 1, with the first transmission unit sending the plurality of control commands through a global system for mobile communication, with the plurality of second transmission units sending the transaction data through the global system for mobile communication.

3. The accounting system as claimed in claim 2, further comprising: a cell phone, with the cell phone capable of controlling the first control unit through the global system for mobile communication to generate the plurality of control commands, with the first transmission unit sending the plurality of control commands to the plurality of second transmission units, with each of the plurality of second control units receiving one of the plurality of control commands from one of the plurality of second transmission units and reading the transaction data of one of the plurality of automated transaction apparatuses electrically connected to the second control unit, with each of the plurality of second transmission units transmitting the transaction data of one of the plurality of automated transaction apparatuses electrically connected to the second transmission unit to the first transmission unit, with the first control unit reading the transaction data transmitted to the first transmission unit and sending the transaction data to the computer to proceed with accounting process, with the first transmission unit sending a message containing the accounts data to the cell phone through the global system for mobile communication.
